(19) United States
(12) Patent Application Publication
(10) Pub. No.: US 2025/0238674 A1
(43) Pub. Date: Jul. 24, 2025

(54) DETERMINING HIERARCHICAL INFORMATION FROM AN INTERNET PROTOCOL ADDRESS TO PREDICT AN ENTITY ATTRIBUTE

(71) Applicant: Microsoft Technology Licensing, LLC, Redmond, WA (US)

(72) Inventors: Raymond Elery Ortigas, Brooklyn, NY (US); Mingyang Hu, San Francisco, CA (US); Parvez Ahammad, San Jose, CA (US)

(21) Appl. No.: 18/418,016

(22) Filed: Jan. 19, 2024

(51) Int. Cl. G06N 3/084

(52) U.S. Cl. CPC G06N 3/084

(57) ABSTRACT

Embodiments of the disclosed technologies are capable of predicting entity attributes using an Internet Protocol (IP) address. The embodiments describe obtaining an IP address. The embodiments further describe extracting routing prefixes from the IP address. The embodiments further describe performing multiclass classification using a convolutional neural network applied to the extracted routing prefixes to obtain an entity attribute. The embodiments further describe providing the entity attribute for mapping the entity attribute to digital content.

### TECHNICAL FIELD

Embodiments of the invention relate to the field of entity attribute prediction.

### BACKGROUND

Software applications use computer networks to distribute digital content to user computing devices. The performance of a content distribution system can be measured based on signals generated at the user device, such as clicks, conversions, and other user interface events. Those signals often vary based on how well digital content distributions match the user's preferences and interests.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for extracting hierarchical information from an IP address using components of an entity attribute predictor, in accordance with some embodiments of the present disclosure.

FIG. 2 illustrates an example architecture of a convolutional neural network, in accordance with some embodiments of the present disclosure.

FIG. 3 is an example of an entity graph in accordance with some embodiments of the present disclosure.

FIG. 4 is a flow diagram of an example method for training a neural network model using supervised learning, in accordance with some embodiments of the present disclosure.

FIG. 5 is a flow diagram of an example method for training the neural network model at the user system, in accordance with some embodiments of the present disclosure.

FIG. 6 is a block diagram of a computing system that includes an entity attribute predictor, in accordance with some embodiments of the present disclosure.

FIG. 7 is a flow diagram of an example method for predicting entity attributes using an IP address, in accordance with some embodiments of the present disclosure.

FIG. 8 is a block diagram of an example computer system including an entity attribute predictor, in accordance with some embodiments of the present disclosure.

### DETAILED DESCRIPTION

Devices communicate by transmitting data over a network, such as the Internet. For devices to communicate over the network, devices are assigned an Internet Protocol (IP) address. For example, when a source computing device sends a request for data to a destination computing device, the request for the data includes at least the source computing device's IP address (so the destination computing device can send back the requested data) and the destination computing device's IP address (so the destination computing device receives the request for data).

The Internet is a network organized in a hierarchical structure. The hierarchical structure includes tiers and sub-tiers, which organize the network into various subnetworks. A tier or sub-tier defines a logical and/or physical grouping of networked devices. For example, the global top-tier organization that assigns IP addresses is the Internet Assigned Numbers Authority (IANA). The IANA delegates IP addresses to Regional Internet Registries (RIRs), a sub-tier of the Internet. RIRs can be continental-level registries such as the American Registry for Internet Numbers (ARIN). The RIRs delegate addresses to Local Internet Registries (LIRs), which is another sub-tier of the Internet such as Internet Service Providers (ISPs). Different entities manage (IP) address allocations and assignments for devices in each tier or sub-tier. Other entities that assign IP addresses to devices include content delivery networks (CDNs), Virtual Private Clouds (VPCs), and Virtual Private Networks (VPNs), to name a few. Moreover, some IP address blocks are reserved for use on private networks; the addresses therein can be used by any organization/individual on the private network, but their associated devices are typically explicitly prevented from being addressable or accessible outside the private network. When a device connects to the Internet, an assigning entity (typically an ISP, organization, or company) assigns an IP address to the device from a set of IP addresses that have been allocated to the assigning entity. In other words, the assigning entity is allocated a block of IP addresses that the entity can assign to other networks or computing devices it manages. Once assigned to a device, the IP address can be used to uniquely identify the device in a particular network. In operation, the IP address can be used to address the computing device, and it encodes the various entities involved in its ultimate assignment, including the relevant RIR, LIR, ISP, organization, or company.

One version of the Internet Protocol is Internet Protocol version four (IPV4). An example IPV4 address includes four groups of one byte each, where each byte can have a value in the range of 0 to 255. An example IPV4 address is “192.0.2.1.” As shown by the example, a period separates each byte. Another version of the Internet Protocol is Internet Protocol version six (IPV6). An example IPV6 address includes eight groups of two bytes, where each byte is represented as a hexadecimal digit. An example IPV6 address is “CD00:FE80:0000:1257:0CDE:0000:211E:729C.” As shown in the example, a colon separates each two-byte unit. For ease of description, IPV4 addresses are described, but the systems and methods described herein can be applied to IP addresses configured using any version of the Internet Protocol, including IPV6 addresses and/or other versions of the Internet Protocol.

The elements of the IP address are hierarchically arranged to provide information that locates a computing system in a network (e.g., a subnetwork of the Internet). Parsing an IP address from left to right provides information with respect to the computing device in terms of the computing device's RIR, LIR, and/or company, for example. In other words, the IP address encodes information about each entity that was used to assign a respective portion the IP address to the computing device. For example, the computing device is connected to the Internet in a particular region (i.e., the Regional Internet Registry is a first assigning entity), which includes a particular ISP network (i.e., the ISP as Local Internet Registry is a second assigning entity), which further includes a particular company (i.e., the company is a third assigning entity). For example, the first x bits of the IPV4 address indicate the routing prefix associated with an x subnetwork (also referred to as a subnet). A routing prefix indicates a portion of the IP address that is shared by each computing device on the subnetwork identified by that routing prefix. For example, a subnetwork, represented by a forward slash and a number of bits of the subnetwork (e.g., /24) can address approximately 2⁸=256 hosts because a 32-bit IP address that uses 24 bits to identify a subnet results in 32−24=8 addressing bits. Accordingly, in this example, the /24 subnet is capable of addressing up to 256 computing devices.

Depending on the use or purpose of the network, the number of computing devices that can be interconnected by the subnet can be too large or too small. For example, a subnet assigned to a residential network likely does not need to interconnect 256 computing devices to the Internet, whereas a subnet assigned to a corporate entity may need to interconnect more than 256 computing devices to the Internet. Accordingly, the number of bits defining the subnet is variable, depending on the scale of the entity that assigned the IP address. As a result, the subnet information encoded in any given IP address (or portion thereof) is variable. Additionally, the fluid partitioning of the subnet information in a full IP address varies, based on the idiosyncrasies of how different regions, ISPs, companies, and the like organize themselves. In other words, while each IP address encodes the same information (e.g., the location of a computing system within a subnetwork of the Internet based on the hierarchy of structured subnet information), the format of such encoded information varies.

Moreover, the types of entities that manage subnets can vary widely. For example, in some cases, networks are managed by individuals or groups (e.g., a residential network). In other instances, networks are managed by corporations or other business (e.g., commercial networks).

Aspects of the present disclosure train a neural network to predict one or more entity attributes (e.g., one or more attributes of an IP address-assigning entity) using hierarchical intermediate features extracted from an IP address. For example, using aspects of this disclosure, an entity name (e.g., the name of a group, company, or ISP that is the IP address-assigning entity associated with the management of a network and one example of an entity attribute) can be predicted based on the IP address of a device using the network. Further, an entity size (e.g., the number of people employed by an assigning entity and another example of an entity attribute) associated with the entity managing the network can be predicted based on the IP address of a device using the network. In some aspects of this disclosure, multiclass classification is configured to predict an entity attribute having a highest likelihood of being associated with the IP address, where the predicted entity attribute can include an entity name associated with the IP address, an entity size associated with the IP address, or one or more other attributes associated with the entity associated with the IP address. Some embodiments of the present disclosure encode the IP address into an embedding. While the present disclosure describes devices as being assigned IP addresses from an IP address-assigning entity, (e.g., a source computing device and a destination computing device), it should be appreciated that the systems and methods described herein apply to Network Address Translations (NAT) or other gateway IPs. For example, an IP address-assigning entity can assign an IP address to a NAT and the IP address of the NAT can be used to predict attributes of the assigning entity.

Conventional attempts to predict attributes associated with an IP address use rule-based systems to generate and store massive tables that store IP addresses and related information. For example, a rule-based system can use string matching to map IP addresses to one or more subnetworks and store the results of the mapping, e.g., geographic, regional, and/or CDN information associated with the IP address. Additional mapping can be used to map subnetwork information to entity information, such as the name of the entity associated with the IP address. However, such rule-based systems require significant resources to store and maintain these mapping tables. Additionally, the conventional rule-based systems are not scalable, e.g., as new versions of the Internet Protocol are promulgated. For example, a table based on IPV4 IP addresses would be entirely different from a table based on IPV6 addresses. Moreover, changes in IP addresses (e.g., IP address reassignments) make entries stored in the table potentially inaccurate or quickly out of date. Additionally, such rule-based systems can inaccurately predict attributes associated with the IP address and/or imprecisely predict attributes associated with the IP address. Accuracy is reflected through conventional classification metrics, including precision (what percentage of entity attribute predictions are correct) and recall (what percentage of entities with a given attribute are correctly predicted). A technical challenge, therefore, is to leverage the hierarchical information encoded in an IP address to predict attributes of the assigning entity associated with the IP address (e.g., the entity managing the network that allows a computing device assigned to the IP address access to the Internet). A machine learning model trained to predict one or more entity attributes of an IP address causes the machine learning model to learn features of subnetworks. Learning such features allows the machine learning model to recognize the fluid partitioning of subnetworks associated with a given IP address. Employing a machine learning model to predict entity attributes (e.g., as opposed to conventional rule-based systems) decreases the number of predicted false positives (e.g., predicting an incorrect entity attribute) because, for example, the machine learning model can learn more flexibly when to indicate an unknown entity attribute. In contrast, conventional rule-based systems are more likely to greedily map an IP address to an incorrect entity attribute (rather than conservatively indicate unknown), resulting in a false positive.

Predicting one or more entity attributes associated with the IP address advantageously allows for downstream processes to utilize the one or more predicted attributes to map content to the one or more predicted attributes. For example, the predicted one or more entity attributes associated with the IP address can be used to perform content distribution. In a non-limiting example, an IP address can be used to match a predicted entity attribute (e.g., an entity name) to a content distribution such as a news article about a software company performing an operation related to the entity (e.g., a software company).

Another technical challenge includes safeguarding the private information that may be encoded in an IP address, since a full IP address is able to uniquely distinguish computing devices from one another in a subnetwork of the Internet. Removing certain content of the IP addresses prevents the unique identification of a computing device by abstracting the computing device's identity to the network level (e.g., to a subnetwork rather than to the individual device in the subnetwork). Aspects of this disclosure can effectively anonymize a computing device by truncating the device's IP address which groups the truncated IP with other truncated IP addresses of the same subnetwork. Additionally or alternatively, aspects of the present disclosure extract hierarchical information from portions of a computing device's IP address such that potentially user-identifying data remains anonymized. In some embodiments, a neural network is trained to perform entity attribute prediction using multiclass classification. Through machine learning, the neural network develops correlations between entity attributes and truncated IP addresses. The trained neural network then can be used to predict entity attributes based on truncated IP addresses.

Certain aspects of the disclosed technologies are described with reference to a use case of online network-based digital content distribution. An example of a content distribution use case is the targeted distribution of digital content relating to products and/or services using entity attributes predicted by a neural network model. For example, content is marked for distribution to particular entities based on mapping content to entity attributes such as the entity names or the entity size. However, aspects of the disclosed technologies are not limited to product-related content distributions but can be used to improve digital content distribution more generally.

The disclosure will be understood more fully from the detailed description given below, which references the accompanying drawings. The detailed description of the drawings is for explanation and understanding and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains but can be used with or incorporated into other embodiments, including embodiments shown in other drawings.

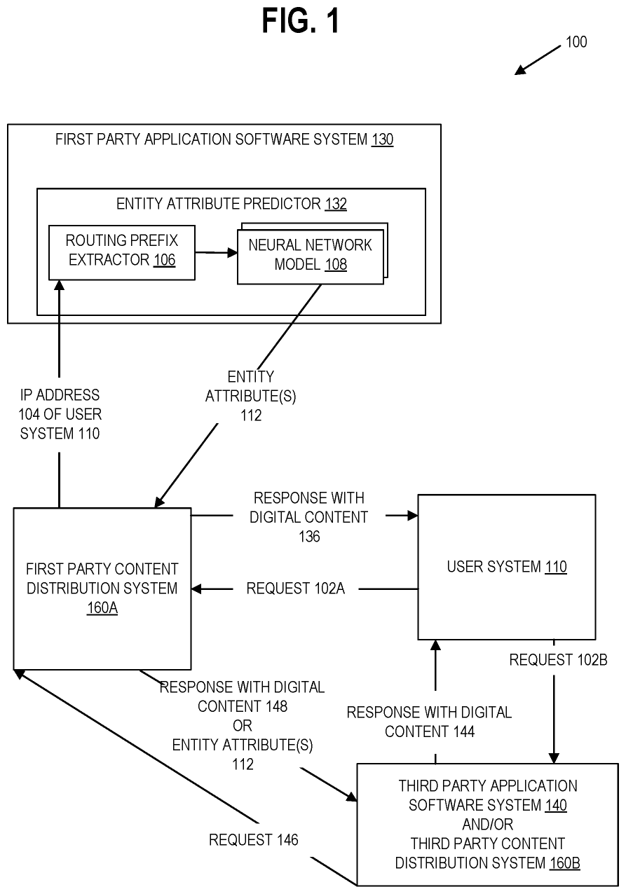

FIG. 1 is a flow diagram of an example method for extracting hierarchical information from an IP address using components of an entity attribute predictor, in accordance with some embodiments of the present disclosure.

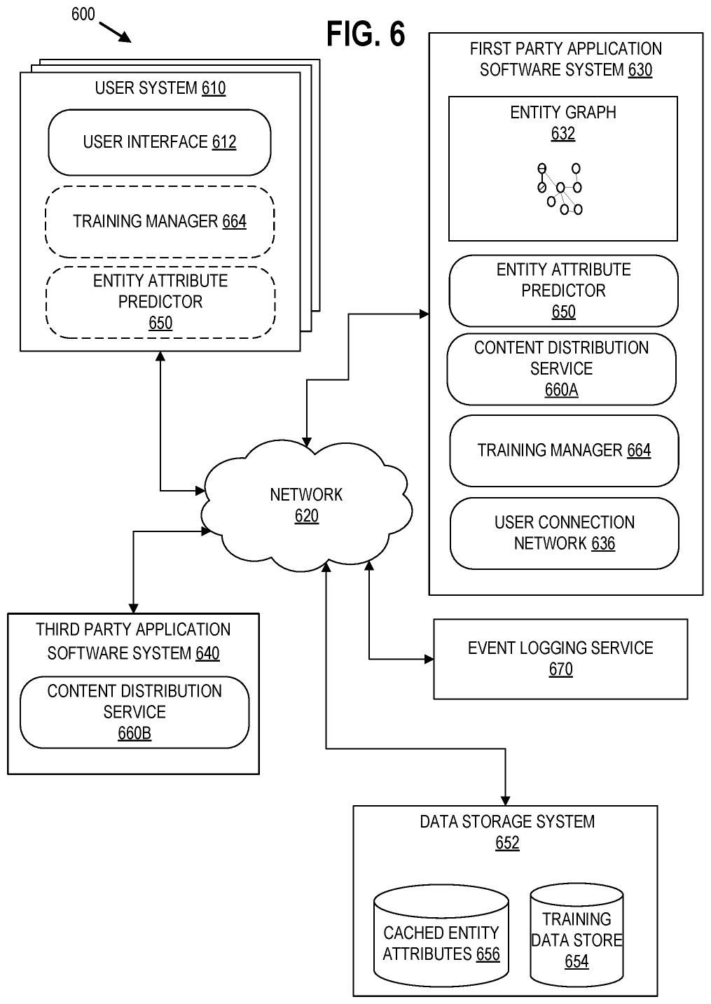

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of an entity attribute predictor 650 of FIG. 6, including, in some embodiments, components shown in FIG. 6 that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In FIG. 1, portions of the routing prefix extractor 106 and the neural network model 108 are collectively represented as entity attribute predictor 132 for ease of discussion only. The routing prefix extractor 106 and the neural network model 108 are not required to be implemented all on the same computing device, in the same memory, or loaded into the same memory at the same time. Further details with regard to the operations of entity attribute predictor 132 are described herein.

In the example of FIG. 1, computing system 100 includes a user system 110, a first party application software system 130, a first party content distribution system 160A, a third-party application software system 140, and/or a third-party content distribution system 160B. The first party application software system 130 of FIG. 1 includes an entity attribute predictor 132. The entity attribute predictor 132 includes a routing prefix extractor 106 and one or more neural network models 108.

User system 110 includes at least one computing device, such as a personal computing device, a server, a mobile computing device, or a smart appliance. User system 110 includes at least one software application, enabling the user system 110 to bidirectionally communicate with the first party content distribution system 160A, the third-party application software system 140, and/or the third-party content distribution system 160B.

First party application software system 130 is any type of application software system that provides or enables at least one form of digital content distribution (such as first party content distribution system 160A) to user systems such as user system 110. Examples of first party application software system 130 include but are not limited to connections network software, such as social media platforms, and systems that are or are not based on connections network software, such as general-purpose search engines, job search software, recruiter search software, sales assistance software, content distribution software, learning and education software, or any combination of any of the foregoing.

First party application as used herein may refer to a software application that is considered the owner of particular data or that has been granted permission by a user to use certain data. For example, an application that requires users to agree to a set of terms and conditions regarding data security may be considered a first party application with respect to data created as a result of the users' use of the first party application. In some embodiments, the first party application software system 130 receives one or more user credentials from user system 110, allowing the user to access one or more applications or digital content provided by the first party application software system 130. In some embodiments, the first party application software system 130 is configured to authorize the user system 110 based on the user credentials matching a stored set of user credentials.

In the example of FIG. 1, the components of the entity attribute predictor 132 are implemented using an application server or server cluster hosted by the first party application software system 130, which can include a secure environment (e.g., secure enclave, encryption system, etc.) for the processing of received data.

Third party application software system 140 is any type of application software system that provides or enables at least one form of digital content distribution to user systems. Examples of third-party application software system 140 include but are not limited to any type of networked software application including mobile apps such as social media platforms, news and entertainment apps, messaging apps, search engines, or any combination of any of the foregoing.

Third party application as used herein may refer to a software application that is different than first party application software system 130 in terms of its publisher, platform, or other considerations. A third-party application may refer to a software application that is considered the owner of particular data or that has been granted permission by a user to use certain data, which is not the first party application software system 130. For example, an application that requires users to agree to a set of terms and conditions regarding data security may be considered a third-party application with respect to data created as a result of the users' use of the third-party application. Certain data owned or used by a third-party application software system 140 is not owned by the first party application software system 130 and the first party application software system 130 may not have been granted permission to use that data. Likewise, certain data owned or used by a first party application software system 130 is not owned by the third-party application software system 140 and the third-party application software system 140 may not have been granted permission to use that data. In some embodiments, the third-party application software system 140 receives one or more user credentials from user system 110, allowing the user to access one or more applications or digital content provided by the third-party application software system 140. In some embodiments, the third-party application software system 140 is configured to authorize the user system 110 based on the user credentials matching a stored set of user credentials.

First party content distribution system 160A and third-party content distribution system 160B (collectively referred to herein as content distribution systems 160) are technology platforms that facilitate access to digital content items across multiple different applications, systems, or networks. As described herein, content distribution systems 160 process content distribution requests from, for example, first party application software system 130 or third-party application software system 140 and distributes digital content items to user systems 110 in response to requests. For example, content distribution system 160 delivers digital content items to web sites and mobile apps or to particular slots of web sites or mobile app user interface display screens.

In some embodiments, a first party application system 130 sends a content distribution request to content distribution system 160A, and the content distribution system 160A may forward the request to multiple different application software systems including first party application software system 130 and/or third-party application software system 140. Additionally or alternatively, a third-party application software system 140 may send a content distribution request to content distribution system 160B, and the content distribution system 160B may forward the request to multiple different application software systems including first party application software system 130 and/or third-party application software system 140. In some embodiments, content distribution systems 160 are owned or managed by a different entity than third party application software system 140 or first party application software system 130. In other embodiments, portions of content distribution systems 160 may be owned or managed by third party application software system 140 and/or first party application software system 130.

Content distribution systems 160 can include data storage services, such as web servers, which store digital content items that may be included in a content distribution. Any network-based application software system can act as the one or more content distribution systems 160. For example, news and entertainment apps installed on mobile devices, messaging systems, and social graph-based applications can all function as content distribution systems. Content distribution systems 160 uses various criteria to match particular digital content items to particular content distributions.

As described herein, content distribution systems 160 can match entity attribute(s) 112 to particular digital content items for content distribution. FIG. 1 shows two different content distribution examples: a first content distribution example that uses a first party content distribution system 160A and a second example that uses a third-party application software system 140 and/or a third-party content distribution system 160B.

In the first party content distribution example, a request 102A is sent to the first party content distribution system 160A from the user system 110. The request 102A can include a request for a first type of digital content and include information such as the IP address associated with the user system 110. As described herein, data requests can include the source computing device IP address such that the requested data is communicated back to the source computing device (e.g., user system 110). The first party content distribution system 160A extracts the source computing device IP address (e.g., IP address 104) and sends the IP address 104 to the entity attribute predictor 132 of the first party application software system 130.

The routing prefix extractor 106 of the entity attribute predictor 132 receives an n bit IP address 104 and can be configured to generate any subset of the possible routing prefixes from IP address 104 (e.g. 32 possibilities in the case of a 32-bit IPV4 address), for the convolutional neural network to analyze. A routing prefix of k bits, where 1≤k≤n, is obtained by applying the Boolean “AND” operation on a k-bit subnet mask, of k ones and n−k zeroes, and the original n-bit IP address 104, yielding the first k bits of IP address 104. The routing prefix encodes the subnetwork of the Internet described by the first k bits of IP address 104, including hierarchical information associated with the subnetwork. From the subset of possible routing prefixes of IP address 104 it is directed to analyze, the neural network model is able to detect patterns of hierarchical subnetworks and therefore predict entity attributes associated with the hierarchical information extracted from the IP address. The subset of possible routing prefixes can include a collection of routing prefixes, for example, a matrix of routing prefixes.

In other embodiments, the routing prefix extractor 106 receives an n-bit IP address and analyzes a truncated m-bit version of the IP address. Accordingly, the routing prefix extractor 106 considers some subset of the possible routing prefixes of the original n-bit IP address, where the prefixes can only be generated by applying subnet masks of m bits or fewer. In some embodiments, the original IP address is already truncated (e.g. by the first party content distribution system 160A and/or the third party application software system 140) before IP address 104 is transmitted to the routing prefix extractor 106. Truncating the IP address preserves private or personal information that may be associated with the IP address. In other words, the least significant bits of the IP address are the most fine-grained bits of the IP address that distinguish unique computing systems. Truncating the IP address anonymizes data at a specific entity level, but does not hide less granular information such as the various subnetworks involved in assigning a computing device an IP address. In other words, the truncated IP address does not preclude analysis of the less granular hierarchical information encoded in the IP address. Using a truncated IP address to generate the routing prefixes preserves privacy by anonymizing fine-grained information while still allowing the neural network model to learn less granular hierarchical information associated with the IP address. That is, the neural network model can still predict one or more entity attributes using the truncated IP address.

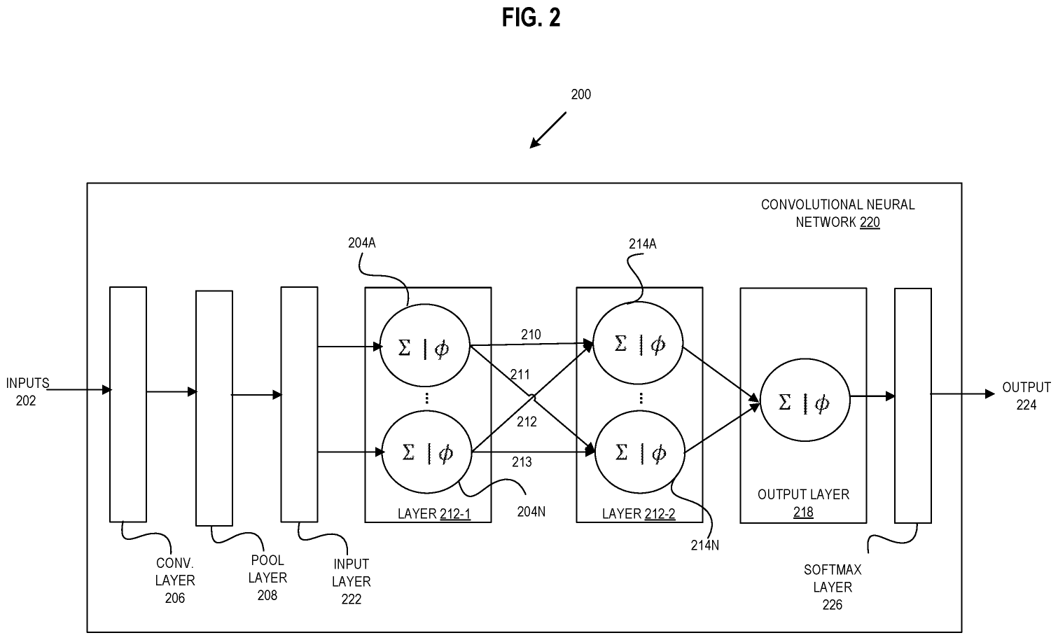

The one or more prefix matrixes are passed to the neural network model 108. In some embodiments, the neural network model 108 is a convolutional neural network (CNN) that analyzes the routing prefixes obtained from the routing prefix extractor 106. The CNN is described in more detail in FIG. 2. In operation, the neural network model 108 predicts one or more entity attributes associated with IP address 104 by performing multiclass classification. In other words, the neural network model 108 predicts one or more entity attributes associated with IP address 104 from a set of one or more entity attributes. For example, the neural network model 108 predicts an entity name associated with the IP address 104 (e.g., an example entity attribute 112). For instance, the neural network model 108 classifies the IP address 104 as having an entity name (e.g., Company A) from a set of possible entity names (e.g., Company A-Company Z). Additionally or alternatively, the neural network model 108 predicts an entity size associated with the IP address 104 (e.g., an example entity attribute 112). For instance, the predicted entity size is “more than 5000 employees” from a set of possible entity sizes (e.g., fewer than 100 employees, between 100 and 5000 employees, more than 5000 employees). In some embodiments, the neural network model 108 is an encoder that determines a latent space representation of the IP address 104 (e.g., an embedding). For example, instead of or in addition to performing multiclass classification, the neural network model 108 generates an embedding of the IP address 104.

In some embodiments, the one or more predicted entity attributes 112 are passed to one or more other applications of the first party application software system 130 (not shown). For example, a downstream application of the first party application software system 130 (not shown) determines additional attributes associated with the one or more entity attributes 112. In a non-limiting example, if an entity attribute 112 is an entity name, an additional attribute associated with the entity attribute 112 is an entity sector. For instance, if the entity attribute 112 is a predicted entity name such a “Company A”, an additional attribute associated with “Company A” may be the technology sector associated with “Company A” (e.g., security, content distribution). In another non-limiting example, if an entity attribute 112 is an entity name, an additional attribute associated with the entity attribute 112 is a growth rate. For instance, if the entity attribute 112 is a predicted entity name such as “Company A” an additional attribute associated with “Company A” is “3% growth per year.” The additional attributes can be determined using one or more other applications of the first party application software system 130 that, for instance, query one or more databases, perform one or more rules-based determinations (e.g., map an entity attribute 112 to an additional attribute), and the like.

In some embodiments, the entity embeddings determined from the entity attribute predictor 132 are passed to one or more other applications of the first party application software system 130 (not shown). For example, a downstream application of the first party application software system 130 (not shown) can use the entity embeddings to retrieve a group profile including a group of entities that share a common characteristic. Identifying groups of entities that share a common characteristic (e.g., the entity embedding) beneficially anonymizes individual members of the group, while still allowing for generalizations of each of the individual members of the group by nature of the group. For example, entities can be grouped based on similar characteristics of the members of the group such as job title or geographic location. For instance, a group profile of “software developers in the Bay Area” could be used to identify a set of entities that have “software developer” as a job title or a job description and “Bay Area” as a geographic location. The group profile can be used to perform content distribution. For example, the group profile can be used to match a set of entities with a content distribution such as a news article about software companies in the Bay Area or a set of job postings by software companies that are currently hiring.

In addition to using the entity attributes 112 and/or the entity embeddings determined by the entity attribute predictor 132 for one or more downstream processes by the first party application software system 130, the entity attributes 112 and/or the entity embeddings can be passed back to the first party content distribution system 160A. For ease of description, the present disclosure describes the first party content distribution system 160A receiving the entity attributes 112, however in other embodiments, the first party content distribution system 160 can receive the entity attributes 112 and/or the entity embeddings.

The first party content distribution system 160A can obtain a first type of digital content responsive to the request 102A requesting the first type of digital content. Additionally or alternatively, the first party content distribution system 160A can map the entity attribute(s) 112 to a second type of digital content. For example, the first party content distribution system 160A applies the request for the first type of digital content and/or the request for the second type of digital content (determined by matching the entity attribute(s) 112 to the second type of digital content) to one or more content repositories or corpus of digital content items (not shown) in the form of a query. For example, the first party content distribution system 160A determines a set of one or more entity attribute 112-matched content items by comparing the entity attribute 112 to a set of content items stored in a corpus of digital content items (e.g., a searchable data store or the Internet).

The first party content distribution system 160A generates a response 136 that includes the requested first type of digital content (e.g., requested by the user system 110) and/or the second type of digital content (e.g., matched to the entity attribute 112 associated with the user system 110). In a non-limiting example, the request 102A includes a request for a first news article, and the response with digital content 136 includes the first news article (e.g., the first type of digital content) and digital content relating to a product (e.g., the second type of digital content), where the digital content relating to the product is targeted based on one or more entity attributes 112 (e.g., entity name, entity size). Content distribution requests and responses are, for example, network messages such as an HTTP (HyperText Transfer Protocol) requests for data, such as a page load, and corresponding HTTP responses.

Alternatively, third party application software system 140 and/or a third-party content distribution system 160B handles a request generated by a user system 110 in cooperation with first party content distribution system 160A. In this second example, the third-party application software system 140 and/or third-party content distribution system 160B receives a request 102B from user system 110. The request 102B can include a request for a first type of digital content and include information such as the IP address associated with the user system 110. In some embodiments, third party application software system 140 and/or third-party content distribution system 160B process the request 102B and provides a corresponding request 146 to first party content distribution system 160A. The request 146 includes at least some of the information contained in request 102B (such as the IP address associated with the user system 110) but is perhaps reformulated into a different format for communication with first party content distribution system 160A. In other embodiments, the third-party application software system 140 and/or third-party content distribution system 160B process the request 102B. For example, the third-party application software system 140 and/or third-party content distribution system 160B extract the IP address from the request 102B and send the IP address (or a truncated version of the IP address) as part of request 146.

The first party content distribution system 160A processes request 146 and extracts the IP address 104 from the request 146. As described above, the IP address 104 is provided to the entity attribute predictor 132 of the first party application software system 130 to obtain one or more entity attributes 112 (or entity embeddings), where the one or more entity attributes 112 are provided to the first party content distribution system 160A. For example, given the IP address 104, the entity attribute predictor 132 determines an entity name and/or an entity size (e.g., examples of entity attributes 112) associated with the IP Address 104.

The one or more predicted entity attributes 112 are passed back to the first party content distribution system 160A. In some embodiments, the first party content distribution system 160 determines a first type of digital content (e.g., associated with request 102B) and/or a second type of digital content associated with the entity attribute 112. For example, the first party content distribution system 160A queries one or more content repositories or corpus of digital content items (not shown) for the first type of digital content (e.g., associated with request 102B) and/or a second type of digital content (determined by matching the entity attribute 112 to a second type of digital content). For example, content distribution system 160A determines a set of one or more entity attribute 112-matched content items by comparing the entity attribute 112 to a set of content items stored in a corpus of digital content items (e.g., a searchable data store or the Internet). In these embodiments, the first party content distribution system 160A generates a response that includes the first type of digital content and/or the second type of digital content. Accordingly, the response 148 includes digital content.

In other embodiments, the first party content distribution system 160A passes the one more entity attribute 112 (or entity embeddings) to the third-party application software system 140 and/or the third-party content distribution system 160B. In these embodiments, the third-party application software system 140 and/or the third-party content distribution system 160B determines a first type of digital content (e.g., associated with request 102B) and/or a second type of digital content associated with the entity attribute 112. For example, the third-party application software system 140 and/or the third-party content distribution system 160B queries one or more content repositories or corpus of digital content items (not shown) for the first type of digital content (e.g., associated with request 102B) and/or the second type of digital content (determined by mapping the entity attribute 112 to the second type of digital content). For example, content distribution system 160B determines a set of one or more entity attribute 112-matched content items by comparing the entity attribute 112 to a set of content items stored in a corpus of digital content items (e.g., a searchable data store or the Internet). In these embodiments, the third-party application software system 140 and/or the third-party content distribution system 160B generates a response that includes the first type of digital content and/or the second type of digital content.

The third party application software system 140 and/or third part content distribution system 160B pass a response with digital content 144 to the user system 110 including the first type of digital content (e.g., based on the request 102B) and/or the second type of digital content (e.g., determined from by the first party content distribution system 160A and/or the third party application software system 140 and/or third part content distribution system 160B based on the received entity attributes 112). Content distribution requests and responses are, for example, network messages such as an HTTP (HyperText Transfer Protocol) requests for data, such as a page load, and corresponding HTTP responses.

The examples shown in FIG. 1 and the accompanying description, above are provided for illustration purposes. This disclosure is not limited to the described examples. Additional or alternative details and implementations are described herein.

FIG. 2 illustrates an example architecture of a convolutional neural network, in accordance with some embodiments of the present disclosure.

A neural network is one example of a machine learning model. Example 200 is an example convolutional neural network (CNN) including one or more convolutional layers. The CNN 220 includes a stack of distinct layers (vertically oriented) that receive an input 202 between convolutional layer 206 and output layer 218.

A convolutional layer such as convolutional layer 206 detects one or more features in input 202 using a collection of kernels (referred to herein as a filter). In a simplified example, high-pass filters detect the present of high frequency signals in an input signal. The output of the high-pass filter are the parts of the signal that have high frequency. In the same manner, filters of a convolutional layer 206 can be designed to track different features of the input 202.

As described herein, an IP address has a hierarchical structure that indicates one or more subnetworks of the network of networks assigned to a source computing device. A first subnetwork encoded in the IP address (e.g., using a first number of bits) can indicate a region associated with the source computing device (e.g., country, continent, state, city, etc.). A second subnetwork encoded in the IP address (e.g., using a second number of bits) can indicate a local subnetwork associated with the source computing device). A third subnetwork encoded in the IP address (e.g., using a third number of bits) can indicate an ISP associated with the source computing device. The first number of bits, second number of bits, and third number of bits may be the same number, different numbers, or some combination (e.g., the first number of bits is the same as the third number of bits, and the second number of bits is different from the first number and the third number). The one or more filters of the one or more convolutional layers 206 derives subnetwork information. In other words, the convolutional layers 306 implicitly extract intermediate subnetwork features such as a regional subnetwork feature, a local subnetwork feature, and an ISP feature. Such features are used to predict one or more entity attributes associated with the IP address.

In the convolutional layer 206, one or more filters are slid over the input 202 and the element-by-element dot product of the filter(s) and the input 202 are stored as a feature map. In example 200 of FIG. 2, the input 202 contains one or more routing prefixes for the n bit IP address. The filter size defines the sliding window used for convolution. In example 200, the filter size in the convolutional layer 206 is a one-dimensional window of dimension n (e.g., the size of the IP address) that is applied to each routing prefix of the one or more routing prefixes. (A routing prefix of k bits is padded at the end with n-k zeros to fit the n-bit window.) The stride defines the step size of the filter when traversing the input 202. In some embodiments, the stride is n such that each routing prefix is convolved one time. In some embodiments, the filter size is n/2 and the stride size is n/4. For example, for a 32-bit IP address (e.g., n bits), a 16-bit window (e.g., n/2) is applied to each routing prefix and the stride size is 8 bits (e.g., n/4). In this example, convolution is applied to adjacent octets of the IP address. In some embodiments, feature maps are concatenated together to create a feature map that is as deep as the number of filters applied to the input 202. In other embodiments, the feature maps may be processed one at a time.

While one convolutional layer 206 is shown, in operation, the CNN 220 can include multiple convolutional layers. Increasing the number of convolutional layers increases the complexity of the features that may be tracked. In some embodiments, different filters are applied in each convolutional layer (e.g., different filter sizes, different strides, etc.). For example, a first convolutional layer is configured to track the regional subnetwork information (e.g., a region subnetwork feature) and the second convolutional layer is configured to track ISP subnetwork information (e.g., an ISP subnetwork feature). In some embodiments, the same filters are applied in each convolutional layer. For example, multiple convolutional layers are configured to track the region subnetwork information (e.g., a region subnetwork feature). Applying the same filter in multiple convolutional layers increases the accuracy of the tracked one or more features in the input.

In some embodiments, one or more pooling layers 208 down sample the feature map determined from the convolutional layer 206. In a pooling layer, a pooling window is applied to the feature map. In some embodiments, the pooling window is a maximum pooling window, which outputs the maximum value of a feature map contained within dimensions the pooling window. In some embodiments, the pooling window is an average pooling window, which outputs the average value of the feature map contained within the dimensions of the pooling window. In some embodiments, convolutional layers 206 and one or more pooling layers 208 alternate to extract abstract features from the input 202.

The input layer 222 can perform some processing of a flattened one-dimensional feature map (e.g., an n-bit vector) received from the one or more convolutional layers 206 and/or one or more pooling layers 208. For example, the input layer 222 can pad the flattened feature map and/or normalize the flattened feature map.

The feature map is passed to a set of fully connected layers, represented as layers 212-1 and 212-2. As shown, the layers 212-1 and 212-2 include neurons (illustrated as nodes 204A-204N and 214A-214N) and weights (e.g., weights 210-213). The weights interconnecting the neurons can be visually represented as the weights 210-213.

Layer 212-1 has nodes 204A-204N, and layer 212-2 has nodes 214A-214N. The nodes 204A-204N and 214A-214N perform a particular computation and are interconnected to the nodes of adjacent layers. For example, node 204A in layer 212-1 is connected to nodes 214A-214N and node 204N in layer 212-1 is connected to nodes 214A-214N, making layers 212-1 and 212-2 fully connected layers. For simplicity, other nodes and other connections are not shown. In some embodiments, the output of one fully connected layer (e.g., layer 212-1) may become the input to a second fully connected layer (e.g., layer 212-2). In some embodiments, additional fully connected layers are implemented to improve the accuracy of the CNN 220. The number of layers and/or neurons in each layer can be deterministically determined and/or updated during a training phase.

Each of the nodes 204A-204N and 214A-214N sum up the values from the adjacent nodes and apply an activation function, allowing the neural network 220 to detect nonlinear patterns in the feature map. Accordingly, the CNN 220 is able to detect partitioned subnetwork information, representing hierarchical subnetworks associated with the IP Address. In some embodiments, the activation function is the rectifier linear function. In alternate embodiments, the activation function may be the hyperbolic tangent or sigmoid function. Each of the nodes 204A-204N and 214A-214N are interconnected by weights 210-213. The weights 210-213 modify the effect of the connected nodes. For example, the node 204A applies an activation function to the feature map to modify the input. The modified input is passed to the node 214A via weight 210. The value of the weight affects how the node 214A in layer 212-2 receives the output of node 204A in layer 212-2. The values of the weights are tuned during training.

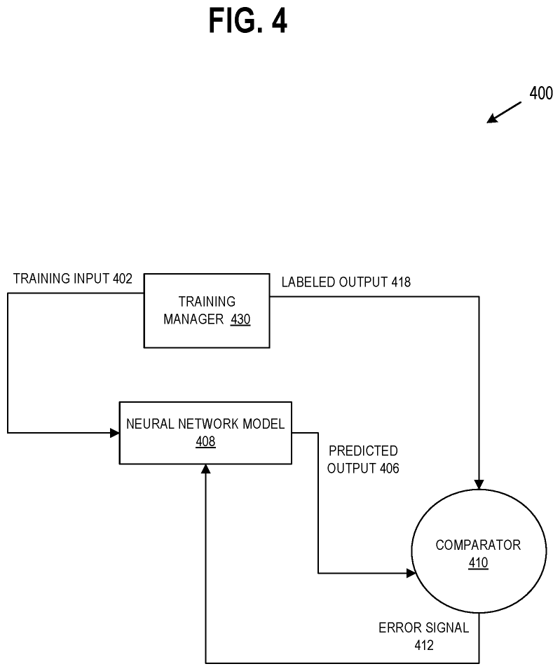

In some embodiments, supervised learning is used to train the CNN 220 during a training phase. Supervised learning, described in detail in FIG. 4, uses input-output pairs (e.g., pairs of training inputs and corresponding labeled outputs) to adjust the values of the weight and/or other hyperparameters during the training phase. In operation, the values of the weights are tuned based on an error (e.g., determined by comparing the output 224 to a labeled output). The error is propagated through the CNN 220 using backpropagation. The error may be calculated each training iteration (e.g., each training input-output pair), batch, and/or epoch and propagated through all of the weights in one or more stacks of layers in the CNN 220 such that the value of the weights adapt based on the amount of error. In some embodiments, the weights are updated by the steepest descent method. Mathematically, for each iteration of training n, the weights are updated according to Equation (1) below:

$${w}_{ji} ( n + 1 ) = {w}_{ji} ( n ) + ∇ {w}_{ji} \qquad ( 1 )$$

In Equation (1) above, wⱼᵢ represents the weight that connects neuron i to neuron j. For example, wⱼᵢ can represent weight 210 that connects neuron 314A to neuron 304A. The steepest descent method is an optimization technique that minimizes a loss function. In other words, the steepest descent method is able to adjust unknown parameters (e.g., the value of each weight) in the direction of steepest descent. During training, the value of the weights that optimize the accuracy of the output 224 is unknown.

Depending on the location of the neuron in the network, a different formula is used to determine how the weights are adjusted with respect to the loss function ε(n). Non-limiting examples of loss functions include the square error function, the room mean square error function, and/or the cross-entropy error function. Mathematically, this is represented according to Equation (2) below:

$$∇ {w}_{ji} = - \frac{\partial ε ( n )}{\partial {w}_{ji ( n )}} \qquad ( 2 )$$

During each training iteration, the weights are tuned to reduce the amount of error thereby minimizing the differences between (or otherwise converging) a predicted output and a labeled output. Training continues until the determined error is within a certain threshold (or a threshold number of batches, epochs, or iterations have been reached).

The output layer 218 receives an input from each of the nodes of the adjacent layer 212-2 to determine a vector of real numbers. The vector of real numbers is passed to a softmax layer 226 (or any other classifier layers) to predict an entity attribute classification associated with the IP address, input as the one or more routing prefixes of input 202. In operation, the softmax layer 226 uses a softmax function, or a normalized exponential function, to transform an input of real numbers into a normalized probability distribution over predicted output classes as output 224. The class associated with the highest probability is selected as the entity attribute classification. For example, when the CNN 220 is trained to predict an entity name (e.g., classify an IP address as having a particular entity name attribute), the output classes include a list of predetermined entity names (e.g., Company A, Company B, Company C, Unknown Company). The output 224 is a probability distribution of each of the predetermined entity names being associated with the IP address. The entity name associated with the highest probability is selected as the most likely entity name associated with the input 202 (e.g., the one or more routing prefixes based on an n-bit IP address). For example, the output classification is “Company A.” Accordingly, the CNN 220 learns to derive meaning by being able to predict entity attributes from the one or more routing prefixes of input 202.

When the CNN 220 is trained to predict an entity size (e.g., classify an IP address as having a particular entity size attribute), the output classes include a list of predetermined entity sizes (e.g., one employee, between 1 and 50 employees, between 51 and 100 employees, Unknown size). The output 224 is a probability distribution of each of the predetermined entity sizes being associated with the IP address. The entity size associated with the highest probability is selected as the most likely entity size associated with the input 202 (e.g., the routing prefixes based on an n-bit IP address). For example, the output classification is “between 1 and 50 employees.”

In some embodiments, the highest probability associated with an entity attribute is compared to a confidence threshold to evaluate the confidence of the CNN's 220 performance. If the highest probability satisfies the confidence threshold, then the highest probability associated with the particular entity attribute e.g., the entity size and/or the entity name) is output as the entity attribute associated with the IP address. If the highest probability does not satisfy the confidence threshold, then the highest probability is not associated with the corresponding classification. In these instances, an error can be displayed, an “unknown” classification is associated with the IP address, and/or a counter is incremented. If the counter satisfies a counter threshold (e.g., the CNN 220 has determined a probability that does not satisfy the confidence threshold a number of times equal to the counter threshold), then an error can be displayed and/or the model can be retrained using supervised learning, as described with reference to FIG. 4.

For example, the output 224 can include a probability distribution indicating that the entity name attribute is 20% Company A and 50% Company B. In some embodiments, the highest probability score (e.g., 50%) is compared to a confidence threshold. If the highest probability score satisfies the threshold (e.g., 40%), then the IP address is classified as being assigned from Company B (e.g., the classification associated with the highest probability and that satisfied the confidence threshold). If the highest probability score does not satisfy the threshold (e.g., 70%), then the IP address can be classified as having an unknown entity name attribute. For example, the highest probability (e.g., 50%) does not satisfy the confidence threshold (e.g., 70%), so instead of classifying the IP address as Company B (associated with the highest probability), the IP address is classified as “Unknown.”

In some embodiments, the class with the highest probability is used for prediction, without any consideration for a confidence threshold. In addition to possibly predicting an entity attribute such as name or size, the model could also possibly predict “Unknown”, if the IP address shares characteristics with other IP addresses which were labeled as “Unknown”.

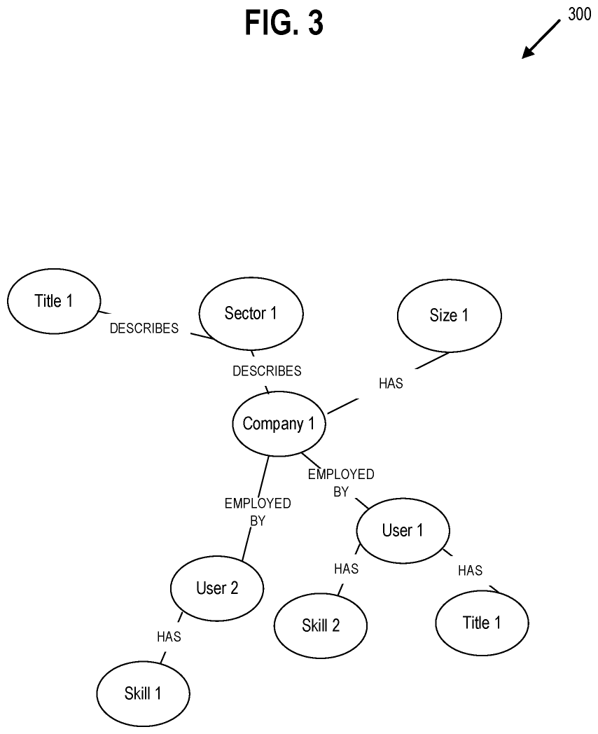

As described herein, the CNN 220 uses a single softmax layer 226 to perform multiclass classification, thereby predicting an entity attribute associated with the IP address. While two types of entity attributes are described, (e.g., an entity name attribute or an entity size attribute), other entity attributes can be predicted by training the CNN 220 using IP addresses and corresponding labeled entity attribute. FIG. 3 described herein is used to illustrate obtaining labeled entity attributes.

In some embodiments, a CNN 220 is trained to perform a single type of multiclass classification. For example, a first CNN 220 receives input 202 and performs a first type of multiclass classification (e.g., predicting an entity name attribute) and a second CNN 220 receives input 202 and performs a second type of multiclass classification (e.g., predicting an entity size attribute).

In some embodiments, the CNN 220 is a multiheaded neural network. Multitask learning is when a single machine learning model (such as CNN 220) is trained to perform multiple tasks. A multiheaded machine learning model includes one or more shared backbone layers and one or more heads trained to perform a specific task. Each head includes one or more layers that perform (in an inference mode) and/or learn (in a training mode) to perform a task associated with that head. In some embodiments, each head may utilize a unique loss function to train the particular head to perform a task. Multitask learning improves efficiency as each head receives the same set of features (or other information) determined from the shared portion of the machine learning model. That is, for a two-headed model, the features received by each head are computed once (e.g., by the shared backbone) instead of twice if each head of the model was its own machine learning model. This efficient sharing is useful in cases where the multitask model learns related tasks.

In one example implementation, the shared backbone of a multiheaded convolutional neural network includes the one or more convolutional layers 206, and one or more pooling layers 208. Accordingly, the shared backbone is used to determine the intermediate subnetwork features of the IP address using one or more feature maps. The one or more feature maps (flattened into a one-dimensional vector, for instance) are fed to a first head and a second head of the neural network.

The first head of the multiheaded neural network includes fully connected layers (such as layers 212-1 and 212-2), output layer 218, and softmax layer 226. The first head is trained to perform mutlticlass classification of a first type of entity attribute such as the entity name attribute. The second head of the multiheaded neural network includes additional fully connected layers (not shown), an additional output layer (not shown), and an additional softmax layer (not shown). The second head is trained to perform multiclass classification of a second type of entity attribute such as the entity size attribute. Accordingly, for a single IP address, entity attributes are predicted (e.g., the entity size attribute determined using the second head and the entity name attribute determined using the first head) using the multiheaded neural network model.

In some embodiments, CNN 220 can be configured to obtain an embedding, instead of a multiclass entity attribute classification. For example, as described herein, the output layer 218 receives an input from each of the nodes of the adjacent layer 212-2 (e.g., the last layer of the fully connected layers 212-1 to 212-2). The output layer 218 generates a vector using each of the inputs from the nodes of the last layer of the fully connected layer 212-2. The vector is a latent space representation indicating the weight of each entity attribute of the set of entity attributes being classified. For example, if the CNN 220 is used to predict entity name attributes, then the vector represents the weight of each entity name attribute of the set of possible entity name attributes. The dimension of the vector corresponds to the dimension of the set of possible entity attributes. For example, if the CNN 220 is trained to classify an IP address as belonging to an entity size of five possible entity sizes, then the dimension of the vector is five. Accordingly, the vector representation is an embedding, or a dense representation of entity attributes related to the input IP address. In these embodiments, the embedding is determined by the CNN 220 for subsequent processing (e.g., instead of, or in addition to, a multiclass entity attribute classification). In other embodiments, the input received from layer 212-2 (e.g., pre-logits) can be an embedding used for subsequent processing, where the dimension of the embedding is based on the number of neurons in the layer (e.g., layer 212-2). In yet other embodiments, the output 224 can include one or more embeddings.

FIG. 3 is an example of an entity graph in accordance with some embodiments of the present disclosure.

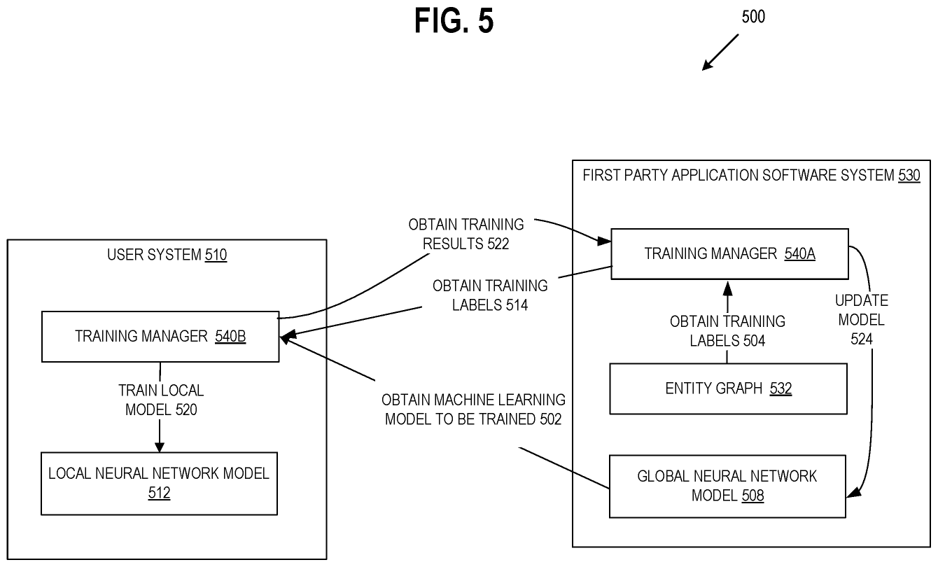

The entity graph 300 can be used by the first party application software system e.g., to obtain training data labels, in accordance with some embodiments of the present disclosure. The training manager (executed at the first party application software system 630 or the user system 610 described in FIG. 6) can train a local entity attribute predictor at the user system or train a global entity attribute predictor at the first party application software system (described in FIGS. 5 and 6) using the labeled data from the entity graph 300.

An entity graph includes nodes, edges, and data (such as labels, weights, or scores) associated with nodes and/or edges. Nodes can be weighted based on, for example, edge counts or other types of computations, and edges can be weighted based on, for example, affinities, relationships, activities, similarities, or commonalities between the nodes connected by the edges.

A graphing mechanism is used to create, update and maintain the entity graph. In some implementations, a graphing mechanism is a component of the database architecture used to implement the entity graph 300. For instance, the graphing mechanism can be a component of data storage system 652 and/or the first party application software system 630 described in FIG. 6, and the entity graphs created by the graphing mechanism can be stored in one or more data stores of data storage system 652.

The entity graph 300 is dynamic (e.g., continuously updated) in that it is updated in response to occurrences of interactions between entities in an online system (e.g., a user connection network, such as user connection network 636 described in FIG. 6) and/or computations of new relationships between or among nodes of the graph. These updates are accomplished by real-time data ingestion and storage technologies, or by offline data extraction, computation, and storage technologies, or a combination of real-time and offline technologies. For example, the entity graph 300 is updated in response to user updates of user profiles.

In the example of FIG. 3, entity graph 300 includes user nodes, which represent users (e.g., User 1 and User 2) and attribute nodes, which represent characteristics (e.g., profile data such as Title 1, Skill 1, Skill 2 and company data such as Section 1) of entities.

Entity graph 300 also includes edges. The edges individually and/or collectively represent various different types of relationships between or among the nodes. Data can be linked with both nodes and edges. For example, when stored in a data store, each node is assigned a unique node identifier and each edge is assigned a unique edge identifier. The edge identifier can be, for example, a combination of the node identifiers of the nodes connected by the edge and a timestamp that indicates the date and time at which the edge was created. For instance, in the graph 400, edges between user nodes can represent information extracted from a user profile such as titles or skills that the user has previously indicated in the user profile or are currently present in the user profile.

The graphic representation of nodes and edges provides information that can be used by the training manager to obtain labels for training data. For example, when a user logs into the user connection service, the training manager can traverse the entity graph 300 for node information that can be used to train the entity attribute predictor. In some embodiments, when a user uses a computing device to log into a user connection service to access a user account, the user credentials associated with the user account are verified or otherwise authenticated. Once authenticated, the training manager obtains the IP address used by the computing device to access the user connection service (e.g., the source computing device IP address). The training manager can traverse the entity graph for labeled data associated with the user and/or entity. For example, if User 1 accesses the user connection service, then, beginning at the “User 1” node of the entity graph 300, the training manager traverses the entity graph 300 to obtain Company 1 by virtue of the EMPLOYED BY edge connecting User 1 to Company 1. In this manner, the training manager obtains an input-output pair. In the example, the input is the User 1 IP address and output is Company 1 (e.g., an example entity attribute).

In some embodiments, the entity graph 300 is populated according to the nodes of the graph. For example, the size of a company can be determined by traversing all of the EMPLOYED BY edges links connecting user nodes to the Company 1 node. Similarly, a sector of a company can be determined by traversing the skills associated with each user employed by company 1. For example, beginning at the Company 1 node and traversing the EMPLOYED BY edges results in user nodes (e.g., User 1 and User 2), attribute nodes such as skill nodes (e.g., Skill 1 and Skill 2) and title nodes (e.g., Title 1) are obtained. Depending on the information that each user uses to populate their profile, users can be associated with skills or titles, by virtue of HAS edges.

In some embodiments, the skill or title nodes (e.g., Skill 1, Skill 2, Title 1) can be used to determine entity attributes such as Sector nodes. For example, User 1 is associated with Title 1 and Skill 2 by virtue of the HAS edge. Some skills or titles may trigger entity attributes. For example, User 1 being employed by company 1 (by virtue of the EMPLOYED BY edge) and being associated Title 1 and Skill 2 (by virtue of the HAS edges) may indicate that Company 1 is associated with Sector 1. In a non-limiting example, a user with a title (e.g., attorney) and skill (e.g., legal research) may indicate that Company 1 is a company in the legal industry (e.g., Sector 1). Accordingly, entity attributes (e.g., a sector) for an entity (such as Company 1) can be determined using the entity graph 300 and the nodes surrounding the entity.

Using the entity graph 300, entity attributes can be obtained. The name of the entity node can be a first entity attribute (e.g., an entity name attribute), the size node connected to the entity node can be a second entity attribute (e.g., an entity size attribute), and the sector node connected to the entity node can be a third entity attribute (e.g., an entity sector attribute, where the sector indicates a related field or technology associated with the entity). For example, a first entity attribute includes a name (e.g., Company 1 node), a second entity attribute includes a size (e.g., Size 1 node), and a third entity attribute includes a sector (e.g., Sector 1 node).

Each entity attribute can be used to train the entity attribute predictor to develop correlations between entity attributes and IP addresses. Moreover, each of the nodes of the entity graph can include the classes used for multiclass classification. For example, entity graph 300 shows Company 1, however, entity graph 300 likely includes other entity name nodes such as Company 2, Company 3, . . . . Company N. Accordingly, each of Company 1 to Company N are classes, and the neural network model (e.g., CNN 220 described in FIG. 2) predicts the most likely class associated with an input IP address from the set of entity name attributes Company 1 to Company N. Similarly, while entity graph 300 shows Size 1, entity graph 300 likely includes other entity sizes such as Size 2, Size 3, . . . . Size M. Accordingly, each of Size 1 to Size M are classes, and the neural network model (e.g., CNN 220 described in FIG. 2) predicts the most likely class associated with an input IP address from the set of entity size attributes Size 1 to Size M. In some embodiments, as described herein, if the CNN 220 is a multiheaded model, each head can predict an entity attribute. For example, for an input IP address, a first head predicts an entity size attribute from the set of entity size attributes Size 1 to Size M, and a second head predicts an entity name attribute from the set of entity name attributes Company 1 to Company N.

In some embodiments, some entities may have no labeled company or size, and furthermore, some of the N possible companies, M possible sizes, etc. may not be predicted, through intentional configuration of the neural network. A special class label (e.g. “Unknown”) may be used to indicate such entity attributes.

The examples shown in FIG. 3 and the accompanying description, above are provided for illustration purposes. This disclosure is not limited to the described examples.

FIG. 4 is a flow diagram of an example method for training a neural network model using supervised learning, in accordance with some embodiments of the present disclosure.

Supervised learning is a method of training a machine learning model given input-output pairs. An input-output pair (e.g., training input 402 and corresponding labeled output 418) is an input with an associated known output (e.g., an expected output, a ground truth). A labeled output 418 can include an entity attribute obtained from entity graph 300 described in FIG. 3, used for training (e.g., a training entity attribute). A training input 402 is a collection of routing prefixes based on an IP address. For example, the training input 402 is a collection of routing prefixes of an IP address of a user accessing a user profile by sending an access request from a user computing device to a web server (e.g., hosting first party application software system 130 described in FIG. 1 for instance), where the user credentials are authenticated or otherwise verified. In some embodiments, the training manager 430 transforms an IP address (or a truncated IP address) into a collection of routing prefixes. For example, the training manager 430 can perform the operations of the routing prefix extractor 106 described in FIG. 1. In other embodiments, the routing prefix extractor transforms a training IP address (obtained from the training manager 430) into a training input routing prefix based on the IP address.

As described herein, the training input 402 is part of training data provided to the neural network model 408 to train the neural network model 408 to classify entity attributes associated with the IP address. For example, a neural network model 408 trained to classify a first entity attribute (e.g., an entity name) can be given a collection of routing prefixes based on an IP address as training input 402 and the corresponding entity name attribute (e.g., Company A) as the labeled output 418. Similarly, the neural network model 408 trained to classify a second entity attribute (e.g., an entity size) can be given a collection of routing prefixes based on an IP address as training input 402 and corresponding entity size attribute (e.g., more than 500 employees) as the labeled output 418.

In operation, the training manager 430 provides, as training input 402, a collection of routing prefixes based on an IP address. The neural network model 408 predicts output 406 by applying nodes in one or more layers of the neural network model 408 to the training input 402. As described herein, a layer may refer to a sub-structure of the neural network model 408 that includes a number of nodes (e.g., neurons) that perform a particular computation and are interconnected to nodes of adjacent layers. Nodes in each of the layers sum up values from adjacent nodes and apply an activation function, allowing the layers to detect nonlinear patterns. Nodes are interconnected by weights, which are adjusted based on an error determined by comparing the labeled output 418 to the predicted output 406. The adjustment of the weights during training facilitates the neural network model's 408 ability to predict a reliable and/or accurate output. In some embodiments, the neural network model 408 is a convolutional neural network. In operation, the comparator 410 compares the predicted output 406 to the labeled output 418 to determine an amount of error or difference between the predicted output 406 and the labeled output 418.

The error (represented by error signal 412) is determined by comparing the predicted output 406 (e.g., a predicted entity attribute associated with the IP address received as training input 402) to the labeled output 418 (e.g., the entity attribute such as an entity name or an entity size associated with the training input 402) using the comparator 410. The error signal 412 is used to adjust the weights in the neural network model 408 such that after a set of training iterations, the neural network model 408 converges, e.g., changes (or learns) over time to generate an acceptably accurate (e.g., accuracy satisfies a defined tolerance or confidence level) predicted output 406 using the input-output pairs. The value of the weights is stored such that the trained neural network model 408 can be deployed during inference time.

FIG. 5 is a flow diagram of an example method for training the neural network model at the user system, in accordance with some embodiments of the present disclosure.

In some embodiments, the training manager 540A of the first party application software system 530 trains a neural network model (e.g., global neural network model 508). In these embodiments, the training manager 540A can train the neural network model using supervised learning, as described in FIG. 4. In other embodiments, the training manager 540B of a user system 510 trains the neural network model (e.g., a local neural network model 512). For example, the training manager 540B uses federated learning to train a local neural network model 512 in user systems 510. Federated learning can increase data privacy by moving models to the data. In other words, local and global neural network model 508 are passed between the user system 510 and the first party application software system 530 such that user information such as an IP address, is not passed between the user system 510 and the first party application software system 530 during training. In some embodiments, the training manager 540A of the first party application software system 530 is the same as the training manager 540B of the user system 510. In other embodiments, the training manager 540A of the first party application software system 530 is different from the training manager 540B of the user system 510. For ease of description, the training manager 540A and training manager 540B can perform similar operations (e.g., training a neural network model such as the local neural network model 512 or the global neural network model 508).

In some embodiments, the user system 510 accesses the first party application software system 530. For example, a user using user system 510 can open a first party application software system 530 application on the user system 510 or access a web server hosting the first party application software system 530. In some embodiments, the first party application software system 530 authenticates or otherwise validates a user by comparing user entered credentials to stored user credentials.

Responsive to accessing the first party application software system 530, the training manager 540B receives the global neural network model 508 from the first party application software system 530. The global neural network model 508 obtained from the first party application software system 530 is treated as a local neural network model 512 on the user system 510. Accordingly, the training manager 540B obtains the machine learning model to be trained 502.

The training manager 540B receives labeled entity attributes based on a user identifier such as a user profile. For example, the training manager 540B can request that the training manager 540A obtain labeled entity attributes from the entity graph 532. In operation, the training manager 540B passes a user identifier (e.g., user profile information) to the training manager 540A. The training manager 540A uses the user identifier to traverse the entity graph 532 to obtain training labels 504. For example, as described with reference to FIG. 3, a user node is connected to an entity node by virtue of EMPLOYED BY edges. Accordingly, the training manager 540A can obtain entity attributes associated with the entity node by traversing edges connecting the entity node to characteristic nodes (e.g., a name of a company represented by an entity, a size node, a sector node) by virtue of the HAS edges. In this manner, the training manager 540A obtains entity attributes that correspond to the user identifier without receiving the IP address of the user system 510. The training manager 540A passes the training labels to the training manager 540B such that the training manager 540B obtains training labels 514 (e.g., entity attributes associated with the user profile).

The training manager 540B trains the local model 520. Supervised training is described with reference to FIG. 5. For example, the training manager 540B obtains the IP address of the user system 510 by virtue of being executed at the user system 510. In some embodiments, the IP address is used to create the routing prefixes used as training input. In other embodiments, a truncated IP address is used to create the routing prefixes used as a training input. In some embodiments, other on-device features are used by the training manager 540B to train the local neural network model 512. An example on-device feature that can be used to train the local neural network model 512 includes the connection type detected when the IP address was observed on the device (e.g., WiFi, 5G). As described herein, the training manager 540B obtained the training labels 514 from the training manager 540A of the first party application software system 530. Accordingly, the training manager 540B has labeled training outputs such as entity name, entity size, or other entity attributes.

The local neural network model 512 receives the training input and determines a predicted output. The predicted output is compared to the labeled data such that the training manager 540B can determine an error. In some embodiments, the error is passed to the training manager 540A. In some embodiments, a gradient associated with each weight is passed back to the training manager 540A. In other embodiments, an updated weight value is passed back to the training manager 540A. Accordingly, the training manager 540A obtains training results 522 from the training manager 540B training the local neural network model 512.

The training manager 540A updates the model 524. For example, the training manager 540A uses the training results to update the global neural network model 508. In some embodiments, the training manager 540A applies the received weight value (obtained as training results 522) to the corresponding weight of the global neural network model 508, updating the weight value of the global neural network model 508. The training manager 540A can similarly apply the received gradient and/or determine a gradient using the received error, obtained as training results 522, to the global neural network model 508.

In some embodiments, multiple user systems 610 train a local neural network model 512. Accordingly, the training manager 540A receives multiple training results from each of the user systems 510 training the local neural network model. The training manager 540A updates model 524 by aggregating the received training results or weighting the received training results. For example, training results obtained from some user systems 510 may be weighted more than training results obtained from other user systems 510 (e.g., based on how often the user system 510 accesses the first party application software system or based on an entity attribute and/or a user attribute).

In some embodiments, after the global neural network model 508 is updated by training manager 540A, the global neural network model 508 is passed to the training manager 540B and treated as the local neural network model 512 for additional training. The processes described herein can iteratively repeat to train the updated global neural network model 608 as the new local neural network model 512.

FIG. 6 is a block diagram of a computing system that includes an entity attribute predictor, in accordance with some embodiments of the present disclosure.

In the embodiment of FIG. 6, a computing system 600 includes one or more user systems 610, a network 620, a first party application software system 630, a third-party application software system 640, a data storage system 652, and an event logging service 670. All or at least some components of the entity attribute predictor 650 are implemented at the first party application software system 630, in some implementations. In some embodiments, as described herein, all or at least some components of the entity attribute predictor 650 are implemented at the user system 610. For example, one or more components of the entity attribute predictor 650 are deployed at the user system 610 for on-device inference such that one or more entity attributes of the user system 610 are predicted. Additionally or alternatively, the training manager 664 trains the entity attribute predictor 650 to predict entity attributes using the IP address of the user system 610 and an entity attribute label obtained from the first party application software system 630. Training the entity attribute predictor 650 at the user system 610 preserves anonymity and is described with reference to FIG. 5. As described in FIG. 5, one or more gradients and/or weights are passed from a local model in the user system 610 to the global model in the entity attribute predictor 650. Dashed lines are used in FIG. 6 to indicate that all or portions of the entity attribute predictor 650 and the training manager 664 can be implemented directly on the user system 610, e.g., the user's client device. In other words, both user system 610 and entity attribute predictor 650 can be implemented on the same computing device. Components of the computing system 600 including the entity attribute predictor 650 are described in more detail below.

User system 610 includes at least one computing device, such as a personal computing device, a server, a mobile computing device, or a smart appliance. User system 610 includes at least one software application, including a user interface 612, installed on or accessible by a network to a computing device. In some embodiments, user interface 612 is or includes a front-end portion of first party application software system 630 and/or a front-end portion of third-party application software system 640. For example, embodiments of user interface 612 include a graphical display screen that includes one or more slots. A slot as used herein refers to a space on a graphical display such as a web page or mobile device screen, into which digital content may be loaded during a content distribution. The locations and dimensions of a particular slot on a screen are specified using, for example, a markup language such as HTML (Hypertext Markup Language). On a typical display screen, a slot is defined by two-dimensional coordinates; however, in a virtual reality or augmented reality implementation, a slot may be defined using a three-dimensional coordinate system.

Many different user systems 610 can be connected to network 620 at the same time or at different times. Different user systems 610 can contain similar components as described in connection with the illustrated user system 610. For example, many different end users of computing system 600 can be interacting with many different instances of first party software application system 630 through their respective user systems 610, at the same time or at different times. Additionally or alternatively, many different user systems 610 can train a local neural network model of the entity attribute predictor 650 using a local training manager 665, as described herein. A typical user of user system 610 can be an administrator or end user of first party application software system 630 and/or third-party application software system 640.

User interface 612 can be used to input search queries and view or otherwise perceive output data that includes data produced by the first party application software system 630 (e.g., output data produced via content distribution service 660A) and/or third-party application software system 640 (e.g., output data produced via content distribution service 660B).

In some implementations, user interface 612 enables the user to upload, download, receive, send, or share types of digital content items, including posts, articles, comments, and shares, and to view or otherwise perceive data and/or digital content produced by first party application software system 630, content distribution service 660A, third party application software system 640, and/or content distribution service 660B. For example, user interface 612 can include a graphical user interface (GUI), a conversational voice/speech interface, a virtual reality, augmented reality, or mixed reality interface, and/or a haptic interface. User interface 612 includes a mechanism for logging in to first party application software system 630 or third-party application software system 640, by clicking or tapping on GUI user input control elements and perceiving digital content. Examples of user interface 612 include web browsers, command line interfaces, and mobile app front ends. User interface 612 as used herein can include application programming interfaces (APIs).

Network 620 includes an electronic communications network. Network 620 can be implemented on any medium or mechanism that provides for the exchange of digital data, signals, and/or instructions between the various components of computing system 600. Examples of network 620 include, without limitation, a Local Area Network (LAN), a Wide Area Network (WAN), an Ethernet network or the Internet, or at least one terrestrial, satellite or wireless link, or a combination of any number of different networks and/or communication links.

First party application software system 630 and third-party application software system 640 include any type of application software system that provides or enables the creation, upload, and/or distribution of at least one form of digital content, between or among user systems, such as user system 610, through user interface 612. For example, first party application software system 630 and/or third-party application software system 640 can include online systems that provide social network services, general-purpose search engines, specific-purpose search engines, messaging systems, content distribution platforms, e-commerce software, enterprise software, or any combination of any of the foregoing or other types of software.

Components of the first party application software system 630 include an entity graph 632, an entity attribute predictor 650, a content distribution service 660A, a training manager 664, and a user connection network 636. Components of the third-party application software system 640 include a content distribution service 660B.

Content distribution service 660A of the first party application software system 630 and content distribution service 660B of the third-party application software system 640 (collectively referred to herein as content distribution service 660) are technology platforms that facilitate access to digital content items across multiple different applications, systems, or networks. As described herein, content distribution service 660 process content distribution requests from, for example, first party application software system 630 or third-party application system 630, and distribute digital content items to user systems 610 in response to requests. For example, content distribution service 660 delivers digital content items to web sites and mobile apps or to particular slots of web sites or mobile app user interface display screens.

In some embodiments, a first party application system 630 sends a content distribution request to content distribution service 660A, and the content distribution service 660A may forward the request to multiple different application software systems including first party application software system 630 and/or third-party application system 640. Additionally or alternatively, a third-party application system 640 may send a content distribution request to content distribution service 660B, and the content distribution service 660B may forward the request to multiple different application software systems including first party application software system 630 and/or third-party application system 640.

Content distribution service 660 can include data storage services, such as web servers, which store digital content items that may be included in a content distribution. Any network-based application software system can act as the one or more content distribution service 660. For example, news and entertainment apps installed on mobile devices, messaging systems, and social graph-based applications can all function as content distribution systems. Content distribution service 660 uses various criteria to match particular digital content items to particular content distributions.

A front-end portion of first party application software system 630 can operate in user system 610, for example as a plugin or widget in a graphical user interface of a web application, mobile software application, or as a web browser executing user interface 612. In an embodiment, a mobile app or a web browser of a user system 610 can transmit a network communication such as an HTTP request for content provided by the first party application software system 630 via content distribution service 660A over network 620 in response to user input that is received through a user interface provided by the web application, mobile app, or web browser, such as user interface 612. A server of the first party application software system 630 can receive the input from the web application, mobile app, or browser executing user interface 612, perform at least one operation using the input (e.g., predict an entity attribute using the entity attribute predictor 650), and return an output (such as digital content associated with the predicted entity attribute) to the user interface 612 using a network communication such as an HTTP response, which the web application, mobile app, or browser receives and processes at the user system 610710.

Similarly, a front-end portion of third-party application software system 640 can operate in user system 610, for example as a plugin or widget in a graphical user interface of a web application, mobile software application, or as a web browser executing user interface 612. In an embodiment, a mobile app or a web browser of a user system 610 can transmit a network communication such as an HTTP request for content provided by the third-party application software system 640 via content distribution service 660B over network 620 in response to user input that is received through a user interface provided by the web application, mobile app, or web browser, such as user interface 612. A server of the third party application software system 640 can receive the input from the web application, mobile app, or browser executing user interface 612, perform at least one operation using the input (e.g., transmit an IP address received as part of the data from the user system 610 to the first party application software system 630, and receive a predicted entity attribute from the first party application software system's 630 use of the entity attribute predictor 650), and return an output (such as digital content associated with the predicted entity attribute) to the user interface 612 using a network communication such as an HTTP response, which the web application, mobile app, or browser receives and processes at the user system 610.

A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, or a page load.

In the example of FIG. 6, the first party application software system 630 includes a training manager 664. The training manager 664 trains one or more machine learning models. For example, the training manager trains a classifier (e.g., the CNN 220 described in FIG. 2) using IP addresses (e.g., a collection of routing prefixes generated from full length IP addresses or a truncated IP addresses) and known entity attributes such as the entity name that is providing the user system access to the Internet via the IP address or the size of the entity that is providing the user system access to the Internet via the IP address. The training manager 664 can also train a machine learning model to generate an embedding using an IP address. Training a machine learning model is described in more detail with reference to FIG. 4.

The entity attribute predictor 650 is trained (by the training manager 664 operated at the first party application software system 630 and/or by the training manager 664 operated at the user system 610) to classify an IP address as belonging to one or more entity attributes. The hierarchical information encoded in the IP address is decomposed such that intermediate features of the IP address are learned. The intermediate features are the subnetworks used to locate the computing device assigned to the IP address in the Internet. For example, the intermediate features include a geography subnetwork, a regional subnetwork, a local subnetwork, or an ISP subnetwork. Learning such intermediate features allows the entity attribute predictor 650 to predict an entity attribute associated with the IP address.

In the example of FIG. 6, the first party application software system 630 includes an entity graph 632. Entity graph 632 includes data organized according to graph-based data structures that can be traversed via queries and/or indexes to determine relationships between entities. An example of an entity graph is shown in FIG. 3, described herein. For example, as described in more detail with reference to FIG. 3, entity graph 632 can be used to obtain training data used, by the training manager 664, to train the entity attribute predictor 650 to predict an entity attribute associated with a user identifier (e.g., a user profile).

Entity graph 632 includes a graph-based representation of data stored in data storage system 652, described herein. For example, entity graph 632 represents entities, such as users, organizations, and content items and entity characteristics such as entity name, entity size, entity skills, and entity titles, as nodes of a graph. Entity graph 632 represents relationships, also referred to as mappings or links, between or among entities as edges, or combinations of edges, between the nodes of the graph. In some implementations, the edges, mappings, or links indicate online interactions or activities relating to the entities connected by the edges, mappings, or links. For example, information about a user can be obtained by traversing the entity graph 632. Accordingly, IP addresses assigned to user systems 610 accessing a user profile (e.g., a node of the entity graph 632) can be mapped to entity attributes extracted from the entity graph 632.

Portions of entity graph 632 can be automatically re-generated or updated from time to time based on changes and updates to the stored data, e.g., updates to entity data and/or activity data. For example, changes to a user's place of employment, a user's job title, a user's skills, may trigger re-generating portions of entity graph 632.

User connection network 636 includes, for instance, a social network service, professional social network software and/or other social graph-based applications. In some embodiments, the user connection network 636 is used to populate the entity graph 632. For example, a user interacting with the user connection network 636 causes one or more changes to the entity graph 632. For instance, a user may update their place of employment, causing an update to a node in the entity graph 632.

Event logging service 670 captures and records network activity data generated during operation of the first party application software system 630 and/or third-party application software system 640, including user interface events generated at user systems 710 via user interface 612, in real time, and formulates the user interface events into a data stream that can be consumed by, for example, a stream processing system. Examples of network activity data include clicks on messages or graphical user interface control elements, the creation, editing, sending, and viewing of digital content, and social action data such as likes, shares, comments. For example, when a user of first party application system 730 or third party application system 740 clicks on a user interface control such as updating the user's profile information, the event logging service fires an event to capture an identifier (e.g., an IP address), an event type, a date/timestamp at which the user interface event occurred, and possibly other information about the user interface event, such as the impression portal and/or the impression channel involved in the user interface event (e.g., device type, operating system, etc.). Examples of impression portals and channels include, for example, device types, operating systems, and software platforms, e.g., web or mobile. Event logging service 670 generates a data stream that includes a record of real-time event data for each user interface event that has occurred.

Conversion as used herein refers to a user interface event or combination of user interface events that counts as an interaction with a product, service, or digital content item that has been defined as valuable to the provider of the product, service, or digital content item. Examples of conversion events include initiating and/or completion of an online sales transaction with the provider, generation of a message to the provider, a visit to the provider's website, and filling out an online form of the provider. When an interaction is initiated by a first party application but the conversion occurs within a third party application system, e.g., by a visit to a third party web page, the user interface event data associated with the conversion may be owned by the third party application system and thus subject to data security rules that prevent or restrict the sharing of individualized entity information outside of the third party application system.

The event logging service 670 generates a data stream that includes one record of real-time event data for each user interface event that has occurred. Time as used in the context of terminology such as real-time refers to a time delay introduced by the use of computer technology, e.g., by automated data processing and/or network transmission, where the time delay is the difference in time, as measured by a system clock, between the occurrence of an online event and the use of data processed in response to the event, such as for display, feedback, and/or control purposes.

Data storage system 652 includes data stores and/or data services that store digital data received, used, manipulated, and produced by first party application software system 630 and/or third-party application system 640, including cached entity attributes 656, machine learning model training data stored in training data store 654, and trained machine learning model parameters. For example, in some embodiments, the data storage system 652 stores mapped entity attributes to additional entity attributes (e.g., a company name is mapped to a company growth rate) in the cached entity attribute 656 data store. In operation, the first party application software system 630 queries the cached entity attribute 656 data store of the data storage system 652 for one or more additional attributes related to the predicted entity attribute determined via the entity attribute predictor 650. The training data store 654 stores data used to train the entity attribute predictor 650. For example, pairs of IP addresses and entity attributes are stored for training a neural network model using supervised learning.

In some embodiments, the data storage system 652 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of the data storage system 652 can be configured to store data produced by real-time and/or offline (e.g., batch) data processing. A data store configured for real-time data processing can be referred to as a real-time data store. A data store configured for offline or batch data processing can be referred to as an offline data store. Data stores can be implemented using databases, such as key:value stores, relational databases, and/or graph databases. Data can be written to and read from data stores using query technologies, e.g., SQL or NoSQL.

A key:value database, or key:value store, is a nonrelational database that organizes and stores data records as key:value pairs. The key uniquely identifies the data record, i.e., the value associated with the key. The value associated with a given key can be, e.g., a single data value, a list of data values, or another key:value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

The data storage system 652 resides on at least one persistent and/or volatile storage device that can reside within the same local network as at least one other device of computing system 600 and/or in a network that is remote relative to at least one other device of computing system 600. Thus, although depicted as being included in computing system 600, portions of data storage system 652 can be part of computing system 600 or accessed by computing system 600 over a network, such as network 620.

While not specifically shown, it should be understood that any of user system user system 610, first party application software system 630, third party application software system 640, data storage system 652, and event logging service 670 includes an interface embodied as computer programming code stored in computer memory that when executed causes a computing device to enable bidirectional communication with any other of user system 610, first party application software system 630, third party application software system 640, data storage system 652, and event logging service 670 using a communicative coupling mechanism. Examples of communicative coupling mechanisms include network interfaces, inter-process communication (IPC) interfaces and application program interfaces (APIs).

Each of user system 610, first party application software system 630, third party application software system 740, data storage system 652, and event logging service 670 is implemented using at least one computing device that is communicatively coupled to electronic communications network 620. Any of user system 610, first party application software system 630, third party application software system 640, data storage system 652, and event logging service 670 can be bidirectionally communicatively coupled by network 620. User system 610 as well as other different user systems (not shown) can be bidirectionally communicatively coupled to first party application software system 630 and/or third-party application software system 640.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 610, first party application software system 630, third party application software system 640, data storage system 652, and event logging service 670 are implemented using computer software, hardware, or software and hardware, and can include combinations of automated functionality, data structures, and digital data, which are represented schematically in the figures. User system 610, first party application software system 630, third party application software system 640, data storage system 652, and event logging service 670 are shown as separate elements in FIG. 6 for ease of discussion but, except as otherwise described, the illustration is not meant to imply that separation of these elements is required. The illustrated systems, services, and data stores (or their functionality) of each of user system 610, first party application software system 630, third party application software system 640, data storage system 652, and event logging service 670 can be divided over any number of physical systems, including a single physical computer system, and can communicate with each other in any appropriate manner.

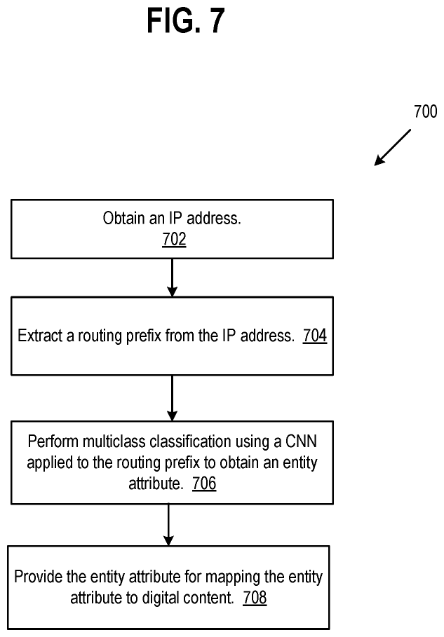

FIG. 7 is a flow diagram of an example method for predicting entity attributes using an IP address, in accordance with some embodiments of the present disclosure.

The method 700 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 800 is performed by one or more components of the entity attribute predictor 650 or the first party application software system 630 of FIG. 6 or the entity attribute predictor 132 or the first party application software system 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 702, a processing device obtains an IP address. For example, a user using a computing device requests data from an application. Responsive to receiving the request, the application obtains the user system IP address. The IP address is a unique identifier that allows the computing device to access the Internet. In operation, the IP address addresses the computing device in terms of a geographic subnetwork, a regional subnetwork, a local subnetwork, or an ISP subnetwork. Accordingly, the computing device assigned the IP address that requested data can receive data.

At operation 704, the processing device extracts a routing prefix from the IP address. In some implementations, the IP address is truncated before the routing prefix is extracted. In some embodiments, a collection of routing prefixes is generated from the routing prefix. For example, each routing prefix represents a possible subnetwork that may be associated with the IP address. In some embodiments, the routing prefixes are generated by applying the Boolean “AND” operation to the IP address and a subnet mask.

At operation 706, the processing device performs multiclass classification using a convolutional neural network (CNN) applied to the routing prefix. In operation, the CNN classifies an IP address as belonging to one or more entity attributes of a set of entity attributes. Entity attributes can include an entity name or an entity size. For example, the CNN is trained to decompose the hierarchical information encoded in the IP address to learn intermediate features of the IP address. The intermediate features are the subnetworks used to locate the computing device assigned to the IP address in the Internet. For example, the intermediate features include a geographic subnetwork, a regional subnetwork, a local subnetwork, or an ISP subnetwork. Learning such intermediate features allows the CNN to predict an entity attribute associated with the IP address. Specifically, one or more layers of the CNN extract an intermediate subnetwork feature (e.g., a geography subnetwork feature, a regional subnetwork feature, a local subnetwork feature, or an ISP subnetwork feature).

In some implementations, the CNN is trained using a training IP address and a corresponding training entity attribute. For example, the processing device can obtain a training entity attribute associated with the training IP address using user information in a user profile. In some implementations, the IP address is assigned to a computing device accessed by a user with a user profile. When the computing device accesses the application, the IP address can be stored as a training IP address. A graph representation of the user profile can be traversed to obtain entity attributes associated with the user profile. Such attributes, used during training of the CNN, are training entity attributes. Accordingly, training data comprising training IP addresses and training entity attributes are obtained.

The CNN is trained using supervised learning, which includes training the CNN with the training IP address and training entity attribute pairs. In operation, the CNN is provided a collection of routing prefixes based on a training IP address and predicts a training entity attribute classification. For example, the CNN can classify the IP address as being associated with an entity name attribute from a set of possible entity names. Additionally or alternatively, the CNN can classify the IP address as being associated with an entity size attribute from a set of possible entity sizes. The predicted entity attribute is compared to the training entity attribute and an error is determined. The error is backpropagated through one or more layers of the CNN. Training is iteratively performed until the determined error is within a certain threshold (or a threshold number of batches, epochs, or iterations have been reached).

At operation 708, the processing device provides the entity attribute for mapping the entity attribute to digital content. For example, one or more downstream or upstream processes can map the entity attribute (e.g., a company name) to digital content relating to products and/or services associated with the company name.

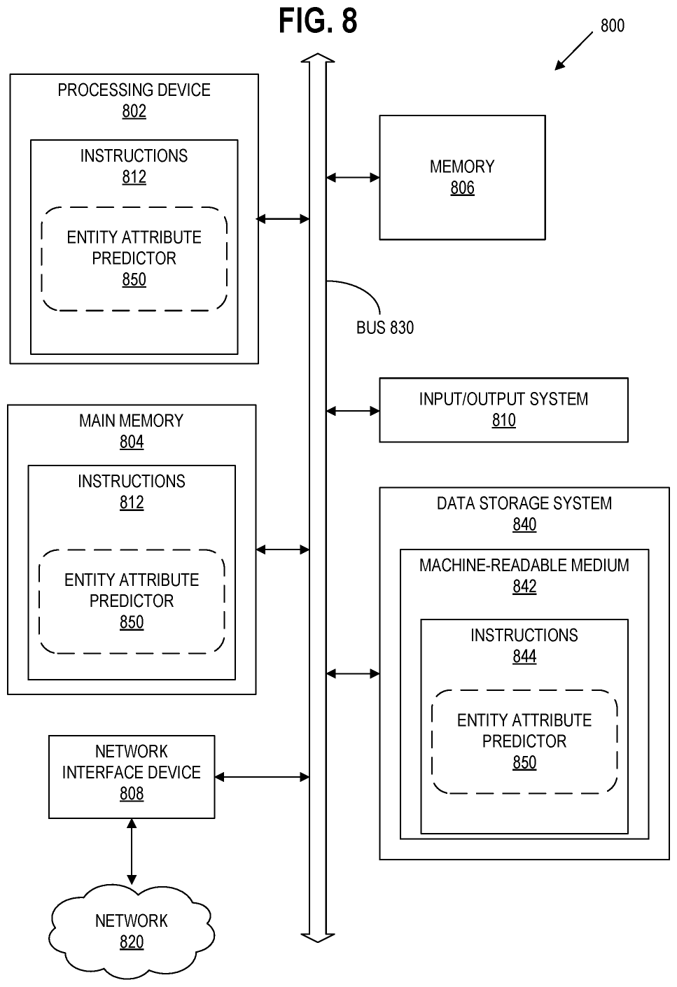

FIG. 8 is a block diagram of an example computer system including an entity attribute predictor, in accordance with some embodiments of the present disclosure.

In FIG. 8, an example machine of a computer system 800 is shown, within which a set of instructions for causing the machine to perform any of the methodologies discussed herein can be executed. In some embodiments, the computer system 800 can correspond to a component of a networked computer system (e.g., as a component of the entity attribute predictor 132 of FIG. 1 or the first party application software system 630 of FIG. 6) that includes, is coupled to, or utilizes a machine to execute an operating system to perform operations corresponding to one or more components of the entity attribute predictor 132 of FIG. 1 or the first party application software system 630 of FIG. 6. For example, computer system 800 corresponds to a portion of computing system 600 when the computing system is executing a portion of the first party application software system 630 of FIG. 6.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a memory 803 (e.g., flash memory, static random access memory (SRAM), etc.), an input/output system 810, and a data storage system 840, which communicate with each other via a bus 830.

Processing device 802 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be at least one special-purpose processing device such as an application specific integrated circuit (ASIC), a field programmable gate array (FPGA), a digital signal processor (DSP), network processor, or the like. The processing device 802 is configured to execute instructions 812 for performing the operations and steps discussed herein.

In some embodiments of FIG. 8, Entity attribute predictor 850 represents portions of first party application software system 630 of FIG. 6 and/or the first party software application system 130 of FIG. 1 when the computer system 800 is executing those portions of entity attribute predictor 850. Instructions 812 include portions of entity attribute predictor 850 when those portions of the entity attribute predictor 850 are being executed by processing device 802. Thus, the entity attribute predictor 850 is shown in dashed lines as part of instructions 812 to illustrate that, at times, portions of the entity attribute predictor 850 are executed by processing device 802. For example, when at least some portion of the entity attribute predictor 850 is embodied in instructions to cause processing device 802 to perform the method(s) described herein, some of those instructions can be read into processing device 802 (e.g., into an internal cache or other memory) from main memory 804 and/or data storage system 840. However, it is not required that all of the entity attribute predictor 850 be included in instructions 812 at the same time and portions of the Entity attribute predictor 850 are stored in at least one other component of computer system 800 at other times, e.g., when at least one portion of the entity attribute predictor 850 is not being executed by processing device 802.

The computer system 800 further includes a network interface device 808 to communicate over the network 820. Network interface device 808 provides a two-way data communication coupling to a network. For example, network interface device 808 can be an integrated-services digital network (ISDN) card, cable modem, satellite modem, or a modem to provide a data communication connection to a corresponding type of telephone line. As another example, network interface device 808 can be a local area network (LAN) card to provide a data communication connection to a compatible LAN. Wireless links can also be implemented. In any such implementation network interface device 808 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system 800.

Computer system 800 can send messages and receive data, including program code, through the network(s) and network interface device 808. In the Internet example, a server can transmit a requested code for an application program through the Internet and network interface device 808. The received code can be executed by processing device 802 as it is received, and/or stored in data storage system 840, or other non-volatile storage for later execution.

The input/output system 810 includes an output device, such as a display, for example a liquid crystal display (LCD) or a touchscreen display, for displaying information to a computer user, or a speaker, a haptic device, or another form of output device. The input/output system 810 can include an input device, for example, alphanumeric keys and other keys configured for communicating information and command selections to processing device 802. An input device can, alternatively or in addition, include a cursor control, such as a mouse, a trackball, or cursor direction keys for communicating direction information and command selections to processing device 802 and for controlling cursor movement on a display. An input device can, alternatively or in addition, include a microphone, a sensor, or an array of sensors, for communicating sensed information to processing device 802. Sensed information can include voice commands, audio signals, geographic location information, haptic information, and/or digital imagery, for example.

The data storage system 840 includes a machine-readable storage medium 842 (also known as a computer-readable medium) on which is stored at least one set of instructions 844 or software embodying any of the methodologies or functions described herein. The instructions 844 can also reside, completely or at least partially, within the main memory 804 and/or within the processing device 802 during execution thereof by the computer system 900, the main memory 804 and the processing device 802 also constituting machine-readable storage media. In one embodiment, the instructions 844 include instructions to implement functionality corresponding to the first party application software system 130 of FIG. 1 (e.g., entity attribute predictor 850 or first party application software system 630 of FIG. 6).

Dashed lines are used in FIG. 8 to indicate that it is not required that the Entity attribute predictor 850 be embodied entirely in instructions 812, 814, and 844 at the same time. In one example, portions of the entity attribute predictor 850 are embodied in instructions 814, which are read into main memory 804 as instructions 814, and portions of instructions 812 are read into processing device 802 as instructions 812 for execution. In another example, some portions of the entity attribute predictor 850 are embodied in instructions 844 while other portions are embodied in instructions 814 and still other portions are embodied in instructions 812.

While the machine-readable storage medium 842 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 8 and the accompanying description above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 700 computing system 600, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
obtaining an Internet Protocol (IP) address;
extracting a routing prefix from the IP address;
performing multiclass classification using a convolutional neural network applied to the routing prefix to obtain an entity attribute; and
providing the entity attribute for mapping the entity attribute to digital content.

2. The method of claim 1, wherein the entity attribute comprises a name of an entity or attribute of the entity.

3. The method of claim 1, further comprising:
extracting, by one or more layers of the convolutional neural network, an intermediate subnetwork feature.

4. The method of claim 3, wherein the intermediate subnetwork feature comprises at least one of a regional subnetwork feature, local subnetwork feature, or Internet Service Provider (ISP) feature.

5. The method of claim 1, further comprising:
iteratively training the convolutional neural network using a training IP address and a corresponding training entity attribute.

6. The method of claim 5, wherein iteratively training the convolutional neural network further comprises:
comparing a predicted entity attribute to the training entity attribute to determine an error; and
backpropagating the error through one or more layers of the convolutional neural network.

7. The method of claim 1, further comprising:
generating an embedding using the convolutional neural network applied to the routing prefix extracted from the IP address.

8. A system comprising:
at least one processor; and
at least one memory device coupled to the at least one processor, wherein the at least one memory device comprises instructions that, when executed by the at least one processor, cause the at least one processor to perform at least one operation comprising:
obtaining an Internet Protocol (IP) address;
extracting a routing prefix from the IP address;
performing multiclass classification using a convolutional neural network applied to the routing prefix to obtain an entity attribute; and
providing the entity attribute for mapping the entity attribute to digital content.

9. The system of claim 8, wherein the entity attribute comprises a name of an entity or attribute of the entity.

10. The system of claim 8, wherein the instructions, when executed by the at least one processor, cause the at least one processor to perform at least one operation further comprising:
extracting, by one or more layers of the convolutional neural network, an intermediate subnetwork feature.

11. The system of claim 10, wherein the intermediate subnetwork feature comprises at least one of a regional subnetwork feature, local subnetwork feature, or Internet Service Provider (ISP) feature.

12. The system of claim 8, wherein the instructions, when executed by the at least one processor, cause the at least one processor to perform at least one operation further comprising:
iteratively training the convolutional neural network using a training IP address and a corresponding training entity attribute.

13. The system of claim 12, wherein iteratively training the convolutional neural network further comprises:
comparing a predicted entity attribute to the training entity attribute to determine an error; and
backpropagating the error through one or more layers of the convolutional neural network.

14. The system of claim 8, wherein the instructions, when executed by the at least one processor, cause the at least one processor to perform at least one operation further comprising:
generating an embedding using the convolutional neural network applied to the routing prefix extracted from the IP address.

15. A non-transitory machine-readable storage medium comprising instructions that, when executed by at least one processor, cause the at least one processor to perform at least one operation comprising:
obtaining an Internet Protocol (IP) address;
extracting a routing prefix from the IP address;
performing multiclass classification using a convolutional neural network applied to the routing prefix to obtain an entity attribute; and
providing the entity attribute for mapping the entity attribute to digital content.

16. The non-transitory machine-readable storage medium of claim 15, wherein the entity attribute comprises a name of an entity or attribute of the entity.

17. The non-transitory machine-readable storage medium of claim 15, wherein the instructions, when executed by the at least one processor, cause the at least one processor to perform at least one operation further comprising:
extracting, by one or more layers of the convolutional neural network, an intermediate subnetwork feature.

18. The non-transitory machine-readable storage medium of claim 17, wherein the intermediate subnetwork feature comprises at least one of a regional subnetwork feature, local subnetwork feature, or Internet Service Provider (ISP) feature.

19. The non-transitory machine-readable storage medium of claim 15, wherein the instructions, when executed by the at least one processor, cause the at least one processor to perform at least one operation further comprising:
iteratively training the convolutional neural network using a training IP address and a corresponding training entity attribute.

20. The non-transitory machine-readable storage medium of claim 19, wherein iteratively training the convolutional neural network further comprises:
comparing a predicted entity attribute to the training entity attribute to determine an error; and
backpropagating the error through one or more layers of the convolutional neural network.
